(19) United States
(12) Patent Application Publication
(10) Pub. No.: US 2023/0332311 A1
(43) Pub. Date: Oct. 19, 2023

(54) HYDROGEN GENERATION SYSTEM WITH MISSION CRITICAL CONTROL

(71) Applicant: Ohmium International, Inc., Incline Village, NV (US)

(72) Inventors: Chockkalingam Karuppaiah, Incline Village, NV (US); Rasool Aghatehrani, Redwood City, CA (US)

(21) Appl. No.: 18/135,444

(22) Filed: Apr. 17, 2023

Related U.S. Application Data
(60) Provisional application No. 63/332,164, filed on Apr. 18, 2022.

(51) Int. Cl. C25B 15/02; C25B 1/04; C25B 9/65

(52) U.S. Cl. CPC C25B 15/02; C25B 1/04; C25B 9/65

(57) ABSTRACT

The systems and methods described herein provide for a mission critical control of a hydrogen generation system to ensure a downstream receiver receives a critical amount of hydrogen from the system and/or a hydrogen storage tank. In one implementation, a status of a hydrogen storage tank may be compared to a mission critical threshold value and hydrogen may be supplied to the tank to ensure the hydrogen does not fall below the threshold value. Further, the hydrogen generator may utilize reliable sources of energy, such as grid power, to refill a storage tank in response to the tank being below a threshold value. At other times, however, the hydrogen generator may utilize renewable sources of energy to provide a more eco-friendly hydrogen producing system.

### CROSS-REFERENCE TO RELATED APPLICATIONS

This application claims the benefit of U.S. Provisional Patent Application No. 63/332,164, filed on Apr. 18, 2022, the entire contents of which are incorporated herein by reference.

### FIELD OF THE DISCLOSURE

The present disclosure is generally related to a hydrogen generation system that includes control methods and systems for mission critical applications or loads.

### BACKGROUND

Electrolysis (i.e., in the context of clean carbon production in the form of hydrogen) is a rapidly growing and enabling technology that provides a preferable and sustainable alternative to fossil fuels and the resulting environmentally harmful CO₂ emissions. Electrolysis may be described as the process of using electricity to split water into hydrogen and oxygen, with this reaction taking place in a unit called an “electrolyzer.”

Through electrolysis, the electrolyzer system creates hydrogen gas which may be used as an energy source, such as in hydrogen-powered vehicles. The leftover oxygen is released into the atmosphere or can be captured or stored to supply other industrial processes or even medical gases in some cases. The hydrogen gas can either be stored as a compressed gas or liquefied, and since hydrogen is an energy carrier, it can be used to power any hydrogen fuel cell electric application, whether it's trains, buses, trucks, or data centers. The commercial interest in hydrogen fuel (commonly referred to as the fuel cell) is increasing due to the amount of heat that is produced during the electrochemical process.

During this process, hydrogen atoms react with oxygen atoms to form water during oxidation; electrons are released in the process and flow as an electric current through an external circuit. Hydrogen fuel uses the chemical energy of hydrogen to produce electricity as a clean form of energy, with electricity, heat, and water vapor being the only products and byproducts. This process produces zero carbon dioxide, a critical key to reducing greenhouse emissions. Hydrogen fuel cells offer a variety of applications, providing power for automobiles, aircraft, seagoing vessels, and emergency backup power supplies. Hydrogen fuel has additional uses for large stationary (industrial) as well as mobile/portable (personal) applications. Storing hydrogen (I.e., in cryogenic or high-pressure tanks) may present a gating issue in certain applications.

Currently, hydrogen generation systems for industrial purposes do not provide a buffer for mission critical situations. Mission critical situations may be present in systems that require a steady supply of hydrogen to power the system, such as an industrial load in which a loss of hydrogen may result in an unsafe operational condition. By not tracking or providing for excess stored hydrogen for use in mission critical situations, many hydrogen generation systems do not provide downstream systems with an adequate amount of available hydrogen. Further, hydrogen generation systems often do not determine or track the availability of renewable energy sources for storage of additional hydrogen for use in mission critical situations.

### SUMMARY

According to one embodiment, a hydrogen generation system includes a hydrogen generator comprising an electrochemical stack producing hydrogen and a power source receiving an input power signal from a plurality of input power sources and in electrical communication with the electrochemical stack, the plurality of input power sources comprising at least a renewable energy source and a non-renewable energy source. The hydrogen generation system may also include a control system comprising a processor and a non-transitory computer-readable medium encoded with instructions, which when executed by the processor, cause the processor to determine a mission critical threshold value of a storage tank capacity associated with a downstream receiver of generated hydrogen and control, based on a comparison of the mission critical threshold value to a current storage tank capacity measurement, the hydrogen generator to fill a storage tank with hydrogen by selecting the non-renewable energy source or the renewable energy source.

According to another embodiment, a method of controlling a hydrogen generation system comprises determining a mission critical threshold value associated with a downstream receiver of hydrogen generated by a hydrogen generator, the hydrogen generator comprising an electrochemical stack producing hydrogen, a storage tank to store generated hydrogen, and a power source receiving an input power signal from a plurality of input power sources and in electrical communication with the electrochemical stack, the plurality of input power sources comprising at least a renewable energy source and a non-renewable energy source. The method may also include transmitting, to the hydrogen generator, one or more instructions to select, based on a comparison of the mission critical threshold value to a current storage tank capacity measurement of the storage tank, the non-renewable energy source or the renewable energy source to fill a storage tank with hydrogen.

According to yet another embodiment, a non-transitory computer-readable storage medium may have computer-executable program instructions stored thereon. When executed by a processor, the program instructions cause a computing device to perform the operation of determining a mission critical threshold value associated with a downstream receiver of hydrogen generated by a hydrogen generator, the hydrogen generator comprising an electrochemical stack producing hydrogen, a storage tank to store generated hydrogen, and a power source receiving an input power signal from a plurality of input power sources and in electrical communication with the electrochemical stack, the plurality of input power sources comprising at least a renewable energy source and a non-renewable energy source. The instructions may further cause the computing device to transmit, to the hydrogen generator, one or more instructions to select, based on a comparison of the mission critical threshold value to a current storage tank capacity measurement of the storage tank, the non-renewable energy source or the renewable energy source to fill a storage tank with hydrogen.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates shows an exemplary environment for hydrogen production according to aspects of the present disclosure.

FIG. 2 illustrates an embodiment of a hydrogen generator for providing hydrogen to one or more downstream receivers.

FIG. 3 illustrates an example block diagram of a controller for a hydrogen generation system with mission critical control.

FIGS. 4A & 4B are example tables of data or information maintained by databases of a hydrogen production environment or system.

FIG. 5 illustrates a method for providing mission critical services for a downstream receiver of a hydrogen generator or generators.

FIG. 6 illustrates a method for the control system of the hydrogen generating environment to provide mission critical services for a downstream receiver.

FIG. 7 illustrates an exemplary computing system which may be used in implementing embodiments of the present disclosure.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the invention, embodiments, or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

The systems and methods described herein provide high-precision control of hydrogen generation. In particular, the systems and methods provide for a mission critical control of a hydrogen generation system to ensure a downstream receiver receives a critical amount of hydrogen from the system and/or a hydrogen storage tank. In one implementation, a status of a hydrogen storage tank may be compared to a mission critical threshold value and hydrogen may be supplied to the tank to ensure the hydrogen does not fall below the threshold value. Further, the hydrogen generator may utilize reliable sources of energy, such as grid power, to refill a storage tank in response to the tank being below a threshold value. At other times, however, the hydrogen generator may utilize renewable sources of energy to provide a more eco-friendly hydrogen producing system. Through the systems and methods described, a stable and reliable supply of generated hydrogen may be provided to a downstream receiver such that operations of the receiver are not impacted by an under-supply of generated hydrogen.

Some embodiments of this disclosure, illustrating its features, will now be discussed in detail. It can be understood that the embodiments are intended to be open-ended in that an item or items used in the embodiments is not meant to be an exhaustive listing of such items or items or meant to be limited to only the listed item or items.

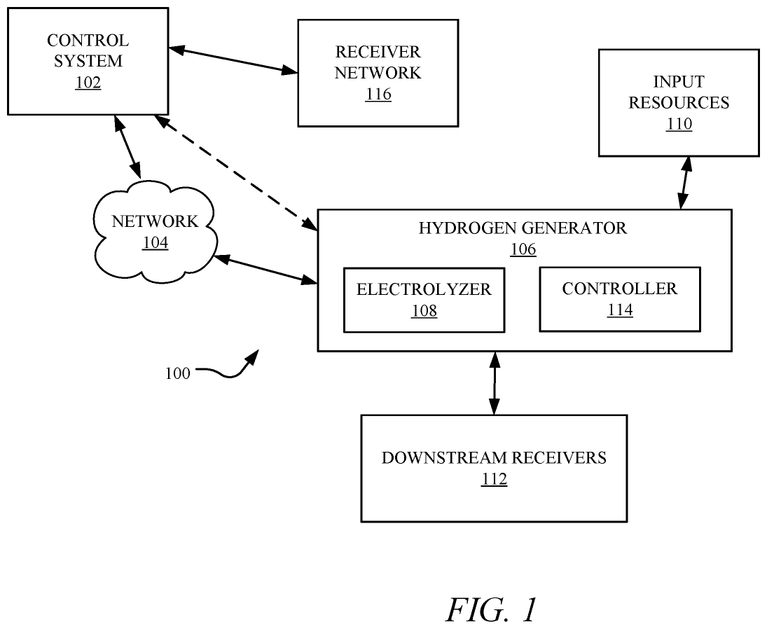

FIG. 1 shows an exemplary environment 100 for hydrogen production according to aspects of the present disclosure. The environment 100 may include more or fewer components than illustrated in FIG. 1, which is included to provide context for the operations and configurations described herein. Additional components and/or configurations of the hydrogen production environment 100 are described in greater detail below.

The environment 100 may include a hydrogen generator 106 designed and configured to generate hydrogen. The hydrogen generator 106 may include a system housed in a container, outdoor-rated cabinets, or multiple systems contained within a site. In one implementation, the hydrogen generator 106 may be a clean hydrogen facility. Such clean hydrogen facility installations are at the early stages of the industry with a significant market growth projection that may scale to much larger production capacity and higher integration adaptation to the upstream and downstream required configurations over time.

As described above, the hydrogen generator 106 generate hydrogen through electrolysis and, more particularly, an electrolyzer or electrolyzer stack 108. The electrolyzer stack 108 is the key equipment component in the hydrogen production process. The quality of the electrolyzer stack 108 determines the operational safety and stability of hydrogen production equipment. The electrolyzer equipment is comprised of various electrolytic cells, and every cell is composed of the main electrode plates, positive net, seal diaphragm gasket, and negative net. An electrolyzer stack, by comparison, comprises multiple cells connected in series in a bipolar design. The stacked bipolar electrolyzer 108 offers a technological engineering solution for the mass production of electrodeposited conducting polymer electrodes for supercapacitors

Most electrolyzers 108 include an anode and a cathode separated by an electrolyte or membrane in the presence of water. As energy, such as a direct-current (DC) power, is applied, the water molecules react at the anode to form oxygen and positively charged hydrogen ions. With the support of an electrolyzer 108, hydrogen and oxygen may be created from a pure water supply and electrical current. Hydrogen can then be utilized to power a fuel cell stack. In particular, hydrogen ions may flow through the electrolyte of the electrolyzer 108 to the cathode to bond with electrons and form hydrogen gas. The leftover oxygen may be released into the atmosphere or can be captured or stored to supply other industrial processes or even medical gases, in some cases. The hydrogen gas can either be stored as a compressed gas or liquefied, and since hydrogen is an energy carrier, it can be used to power such downstream receivers 112 as hydrogen fuel cell applications like trains, buses, trucks, or data centers. In some instances, the generated hydrogen may be provided to one or more downstream industrial plants for asset production, such as steel, cement, oil, fertilizer, and the like. In one example, liquefied hydrogen may be piped to a downstream receiver 112 or carried by tanker.

Electrolyzers 108 can range in size from small equipment, well-suited for modest-scale distributed hydrogen production to large-scale, central production facilities, capable of being sequenced directly to renewable or other non-greenhouse-gas-emitting forms of electricity production. Electrolyzers 108 offer a route to produce clean hydrogen to power hydrogen fuel cells, supply industrial processes or produce green chemicals like fertilizers, renewable natural gas, and methanol.

As should be appreciated, the hydrogen generator 106 may utilize several input resources 110 for generation of hydrogen. For example, various forms of energy sources (grid electricity, natural gas, wind, solar, hydro, etc.) may be provided to the hydrogen facility for use by the components of the generator. Other input resources 110, such as water for use by the electrolyzer 108 may also be provided to the hydrogen generator 106 for producing hydrogen.

The hydrogen generator 106 may include several components in addition to the electrolyzer 108. Control over the various components, systems, programs, and/or sensors of the generator 106 may be executed through a controller 114. For example, a Supervisory Control and Data Acquisition (SCADA) control system 114 may be integrated with the hydrogen generator 106 to monitor generator conditions and/or control various aspects or parameters of the components of the generator. In one particular instance, a sensor may be associated with a pipe containing gas generated from the electrolysis process to measure the pressure within the pipe. The sensor may provide readings or measurements to the controller 114 which may, in response, adjust one or more valves within the gas piping system to adjust the pressure within the piping system. In general, any adjustable aspect or parameter of the hydrogen generator, the components within the generator, input resources 110, sensors, executable program associated with the generator, or any other aspect of the hydrogen generator 106 may be adjustable by the controller 114. In some instances, the controller 114 may also include an interface through which a generator operator may access components of the generator 106 and make one or more adjustments to the components. In another instance, the controller 114 may be configured to automatically adjust the parameters or aspects of the hydrogen generator 106 based on inputs from one or more sensors or any other source of operational data of the generator. Additional details of the controller 114 and the hydrogen generator 106 in general are discussed in more detail below.

The environment 100 may also, in some instances, include a remote or separate control system 102 that communicates with the hydrogen generator 106 either directly or through a network 104 connection. In one example, the control system 102 may be in communication with the electrolyzer 108 to monitor one or more operational states of the electrolyzer and adjust one or more parameters of the electrolyzer accordingly. In other examples, the control system 102 may be in communication with a plurality of hydrogen generators 106 connected together or separate. In general, the control system 102 may be in communication with any number of hydrogen generators 106, each of which may generate some hydrogen as controlled by the control system 102 or by a local controller for the hydrogen generator. The plurality of hydrogen generators may therefore be controlled by the control system 102 to provide a requested amount of hydrogen for one or more downstream receivers 112.

The network 104 may connect the control system 102 to one or more communication interface devices of the hydrogen generator 106 and may be configured to transmit and/or receive information between the remote monitoring system and other devices by way of one or more wired or wireless communication networks or connections. Examples of such networks or connections include, without limitation, wireline communication over serial or Ethernet in copper or fiber medium or wireless communication over USB, Wi-Fi, Bluetooth, Zigbee mesh network, or a cellular wireless network. One or more such communication interface devices may be utilized to communicate with the remote monitoring system 102 and/or the hydrogen generator 106, either directly over a point-to-point communication path, over a wide area network (WAN) (e.g., the Internet), over a local area network (LAN), over a cellular (e.g., third generation (3G), fourth generation (4G), fifth generation (5G)) network, or over another communication means. In some instances, the control system 102 may directly connect to the hydrogen generator 106, such as through a cable connection or backplane connection between the control system and the generator.

The environment 100 of FIG. 1 may also include a receiver network 116 or customer network, which allows receivers of the generated hydrogen to provide requests for hydrogen to the control system 102 or to communicate with the control system in any manner. The receiver network 116 generally allows receivers or users to share information or data with the control system 102 and/or controller 114. For example, the receiver network 116 may receive a request for hydrogen from a system or user associated with a downstream receiver 112. A request module of the receiver network 116 may generate and send a request to the control system 102 activate the electrolyzer 108 of the hydrogen generator 106 to generate hydrogen for the downstream receiver. The receiver network 116 may also include one or more databases storing information associated with the request and receipt of hydrogen from the hydrogen generator 106, such as a client name, the number of electrochemical stacks the customer is currently associated with, and current and past requests for hydrogen, including an amount requested, the date, and the time. Such information may also be maintained by the control system 102 for one or many downstream receivers 112. In other examples, hydrogen requests may be automated by the receiver network 116 and transmitted to the control system 102 either periodically or aperiodically, such as in response to one or more operating conditions of the downstream receiver 112. Communication between the receiver network 116 and the control system 102 is discussed in more detail below.

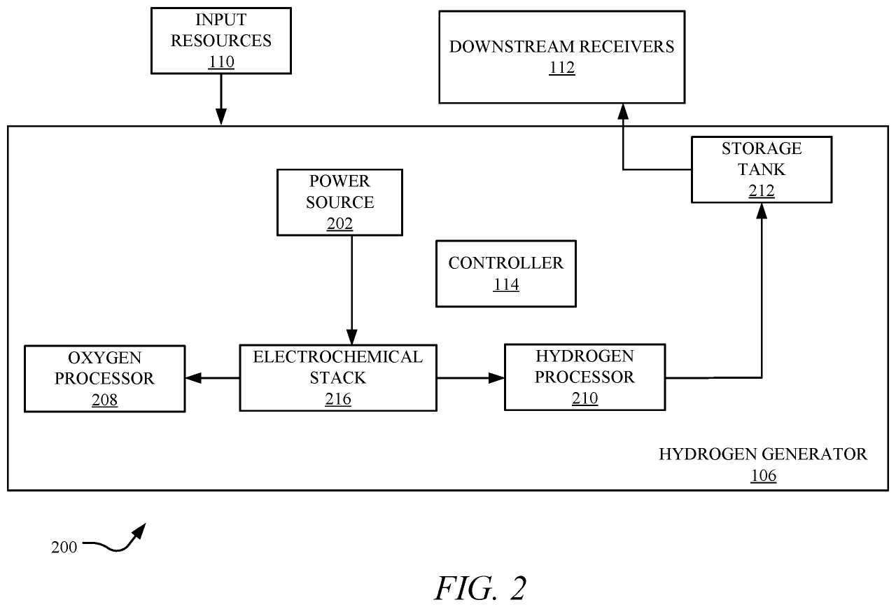

FIG. 2 illustrates an embodiment of the hydrogen generator 106 of the environment 100 discussed above for providing hydrogen to one or more downstream receivers 112, such as industrial plants or other receivers. The hydrogen generator 106 may be the same or similar to that described above with reference to FIG. 1. However, in this illustration, additional components of the hydrogen generator 106 is illustrated, such as an oxygen processor 208, an electrochemical stack 216 (which may include an electrolyzer 108 as discussed above), and a hydrogen processor 210. The oxygen processor 208, the electrochemical stack 216, and the hydrogen processor 210 are fluidically isolated from each other with at least one fluid connector fluidly connecting the oxygen processor and the electrochemical stack and at least one fluid connector fluidly connecting the electrochemical stack and the hydrogen processor. As further discussed below, the hydrogen generator 106 may also include a power source 202, a plurality of gas movers, a controller 114, and a storage tank 212, among other components and systems.

In some instances, the electrochemical stack 216 may include a first membrane electrode assembly (MEA), a second membrane electrode assembly (MEA), and a bipolar plate that collectively defines two complete electrochemical cells for hydrogen generation. The electrochemical stack 216 may also include a first end plate and a second end plate that may sandwich the first MEA, the second MEA, and the bipolar plate into contact with one another and direct the flow of fluids into and out of the electrochemical stack. While the electrochemical stack 216 is described as including two complete cells—a single bipolar plate and two MEAs—it should be appreciated that this is for the sake of clarity of explanation only. The electrochemical stack 216 may alternatively include any number of MEAS and bipolar plates useful for meeting the hydrogen generation demands of the system 200 while maintaining separation between pressurized hydrogen and lower pressure water and oxygen flowing through the electrochemical stack, unless otherwise specified or made clear from the context. The electrochemical stack 216 may include more than one bipolar plate, a single MEA, and/or more than two MEAs. In some embodiments, the bipolar plate may be disposed between the first end plate and the first MEA and/or between the second end plate and the second MEA, without departing from the scope of the present disclosure.

In some embodiments, the first MEA and the second MEA of the electrochemical stack 216 may be identical. For example, the first MEA may include an anode, a cathode, and a proton exchange membrane (e.g., a PEM electrolyte) therebetween. Similarly, the second MEA may include an anode, a cathode, and a proton exchange membrane therebetween. The anodes may each comprise an anode catalyst (i.e., electrode) contacting the membrane and an optional anode fluid diffusion layer. The cathodes may each comprise a cathode catalyst (i.e., electrode) contacting the membrane and an optional cathode gas diffusion layer. The anode electrode may comprise any suitable anode catalyst, such as an iridium layer. The anode fluid diffusion layer may comprise a porous material, mesh or weave, such as a porous titanium sheet or a porous carbon sheet. The cathode electrode may comprise any suitable cathode catalyst, such as a platinum layer. The cathode gas diffusion layer may comprise porous carbon. Other noble metal catalyst layers may also be used for the anode and/or cathode electrodes, including but not limited to ruthenium, rhodium, palladium, osmium, iridium, gold, and silver. The electrolyte may comprise any suitable proton exchange (e.g., hydrogen ion transport) polymer membrane.

The bipolar plate may be disposed between the cathode of the first MEA and the anode of the second MEA. In general, the bipolar plate may include a substrate, an anode gasket, and a cathode gasket. The substrate has an anode (i.e., water) side and a cathode (i.e., hydrogen) side opposite one another. The anode gasket may be fixed to the anode side of the substrate, and the cathode gasket may be fixed to the cathode side of the substrate. Such fixed positioning of the anode gasket and the cathode gasket on opposite sides of the substrate may facilitate forming two seals that are consistently placed relative to one another and relative to the first MEA and the second MEA on either side of the bipolar plate. The gaskets form a double seal around the active areas (i.e., anode (e.g., water) flow field and cathode (e.g., hydrogen) flow field) located on respective opposite sides of the bipolar plate. Further, or instead, in instances in which an electrochemical stack 216 includes an instance of an MEA between two instances of the bipolar plate, the anode gasket and the cathode gasket may form a double seal along an active area of the MEA. Thus, more generally, it shall be appreciated that the anode gasket and the cathode gasket may form a sealing engagement with one or more MEAs in an electrochemical stack to isolate flows within the electrode stack and, thus, reduce the likelihood that pressurized hydrogen may inadvertently mix with a flow of water and oxygen exiting the electrochemical stack 216 to create a combustible hydrogen-oxygen mixture in the system 200.

The substrate may be formed of any one or more of various types of materials that are electrically conductive, thermally conductive, and have strength suitable for withstanding the high pressure of hydrogen flowing along the cathode side of the substrate during use. Thus, for example, the substrate may be at least partially formed of one or more of plasticized graphite or carbon composite. Further, or instead, the substrate may be advantageously formed of one or more materials suitable for withstanding prolonged exposure to water on the anode side of the substrate. Accordingly, in some instances, the anode side of the substrate may include an oxidation inhibitor coating that is electrically conductive, examples of which include titanium, titanium oxide, titanium nitride, or a combination thereof. The oxidation inhibitor may generally extend at least along those portions of the anode side of the substrate exposed to water during the operation of the electrochemical stack 216. The oxidation inhibitor may extend at least along the anode flow field inside the anode gasket on the anode side of the substrate. In some implementations, the oxide inhibitor may extend along the plurality of anode ports (i.e., water riser openings) which extend from the anode side to the cathode side of the substrate. The oxidation inhibitor may also be located in the anode plenums, which connect the anode ports to the anode flow field on the anode side of the substrate.

A cathode ring seal may be located around each cathode port (i.e., hydrogen riser opening) on the anode side of the substrate of the electrochemical stack 216. The cathode ring seal prevents hydrogen from leaking out into the anode flow field on the anode side of the substrate. In contrast, an anode ring seal may be located around each one or more anode ports on the cathode side of the substrate. For example, two anode ports are surrounded by a common anode ring seal to prevent water from flowing into the cathode flow field on the cathode side of the substrate.

The anode flow field may include a plurality of straight and/or curved ribs separated by flow channels oriented to direct a liquid (e.g., purified water) between at least some of the plurality of anode ports, such as may be useful for evenly distributing purified water along the anode of the second MEA. The anode gasket may circumscribe the anode flow field and the plurality of anode ports along the anode side of the substrate to limit the movement of purified water moving along the anode. The anode side of the substrate may be in sealed engagement with the anode of the second MEA via the anode gasket, such that anode channels are located therebetween. Under pressure provided by a source external to the electrochemical stack 216 (e.g., such as the pump of the oxygen processor 208), a liquid provided from the first fluid connector flows along the anode channels is directed across the anode of the second MEA, from one instance of the plurality of anode ports to another instance of the plurality of anode ports, where the liquid (e.g., remaining water and oxygen) may be directed out of the electrochemical stack through a third fluid connector.

Additionally, the substrate may include a plurality of cathode ports (i.e., hydrogen riser openings), each extending from the anode side to the cathode side of the substrate. The cathode side of the substrate may include a cathode flow field. The cathode flow field may include a plurality of straight and/or curved ribs separated by cathode flow channels oriented to direct gas (e.g., hydrogen) toward the plurality of cathode ports, which may be useful for directing pressurized hydrogen formed along with the cathode of the first MEA. Cathode plenums may be located between the cathode ports and the cathode flow field. The cathode gasket may circumscribe the cathode flow field, the cathode plenums, and the plurality of cathode ports along the cathode side of the substrate to limit movement of the pressurized hydrogen along the cathode. For example, the cathode side of the substrate may be in sealed engagement with the cathode of the first MEA via the cathode gasket, such that the cathode flow channels are defined between the cathode of the first MEA and the cathode side of the substrate. The pressure of the hydrogen formed along the cathode may move the hydrogen along at least a portion of the cathode channels and toward the cathode ports located diagonally opposite the cathode inlet port. The pressurized hydrogen may flow out of the cathode ports and out of the electrochemical stack 216 through the second fluid connector to be processed by the hydrogen circuit.

The anode gasket on the anode side of the substrate and the cathode gasket on the cathode side of the substrate may have different shapes. For example, the anode gasket may extend between the plurality of anode ports and the plurality of cathode ports on the anode side of the substrate. In other words, the anode gasket surrounds the anode ports and the anode flow field on one lateral side but leaves the cathode portions outside its circumscribed area. Therefore, the anode gasket may fluidically isolate anode flow from cathode flow in an installed position.

In contrast, the cathode gasket on the cathode side of the substrate may not extend between the plurality of anode ports and the plurality of cathode ports. In other words, the cathode gasket surrounds the anode ports, the cathode portions, and the cathode flow field. Instead, the anode ring seals isolate the anode ports from the cathode ports and the cathode flow field on the cathode side of the substrate.

In one configuration, the anode flow field and the cathode flow field may have the same shape, albeit on the opposite side of the substrate, to provide the same active area along with the first MEA and the second MEA. Thus, taken together, it shall be appreciated that the differences in shape between the anode gasket and the cathode gasket along with positioning of the anode ring seals and the same shape of the anode flow field and the cathode flow field may result in different sealed areas. These different sealed areas are complementary to one another to facilitate fluidically isolating the lower pressure flow of purified water along the anode channels from the pressurized hydrogen flowing along the cathode channels while nevertheless allowing each flow to move through the electrochemical stack 216 and ultimately exit the electrochemical stack along different channels.

In certain implementations, the cathode flow field may be shaped such that a minimum bounding rectangle of the cathode flow field is square. As used in this context, the term “minimum bounding rectangle” shall be understood to be a minimum rectangle defined by the maximum x- and y-dimensions of a cross-section of the cathode flow field. The plurality of cathode ports may include two cathode ports per substrate which are located in diagonally opposite corners from one another with respect to the minimum bounding rectangle (e.g., within the minimum bounding rectangle). The other two diagonally opposite corners lack the cathode ports. In instances in which the minimum bounding rectangle is square, the diagonal positioning of the cathode ports relative to the minimum bounding rectangle may facilitate the flow of pressurized hydrogen diagonally along the entire cathode flow field while leaving a large margin of the substrate material for strengths against the contained internal hydrogen pressure. Alternatively, the substrate may be a rectangle. The plurality of cathode ports may be positioned away from the edges of the substrate such that each one of the plurality of cathode ports is well-reinforced by the material of the substrate between the respective one of the plurality of cathode ports and the closest edge of the substrate.

Given the large pressure differential between the flow of pressurized hydrogen along the cathode channels and the flow of water and oxygen along the anode channels, the electrochemical stack 216 may include the anode fluid diffusion layer disposed in the anode channels and optionally between the anode electrode of the anode of the second MEA and the anode side (e.g., anode ribs) of the substrate. The porous material of the anode fluid diffusion layer may generally permit the flow of water and oxygen through the anode channels without a substantial increase in flow restriction through the anode channels while providing structural support on the anode side of the substrate to resist collapse that may result from the pressure difference on opposite sides of the substrate. It shall be understood, however, the that porous material may be disposed inside all of the anode channels in certain implementations.

Having described various features of the electrochemical stack 216, attention is now directed to a description of the operation of the electrochemical stack to form pressurized hydrogen with water and electricity as inputs. In particular, an electric field E (i.e., voltage) may be applied across the electrochemical stack 216 (i.e., between the end plates) from the power source 202. The bipolar plate may electrically connect the first MEA and the second MEA in series with one another such that electrolysis may take place at the first MEA and the second MEA to form a flow of pressurized hydrogen that is fluidically isolated from lower pressure water and oxygen, except for proton exchange occurring through the proton exchange.

Purified water (not shown) may be introduced into the electrochemical stack 216 via a fluid connection between the oxygen processor and electrochemical stack. Within the electrochemical stack 216, the purified water may flow along an intake channel to direct the purified water to the anode of the first MEA and the anode of the second MEA. With the electric field E applied across the anode and the cathode of the first MEA, the purified water may break down along the anode into protons (H⁺) and oxygen. The protons (H⁺) may move through the proton exchange membrane from the anode to the cathode. At the cathode, the protons (H⁺) may combine to form pressurized hydrogen along the cathode. Through an analogous process, pressurized hydrogen may also be formed along the cathode of the second MEA. The flows of pressurized hydrogen formed by each of the first MEA and the second MEA may combine and flow out of the electrochemical stack 216 via two hydrogen exhaust channels that extends through the bipolar plate, among other components, to ultimately direct the pressurized hydrogen toward the hydrogen processor 210. The flows of oxygen and water along the first anode and the second anode may combine and flow out of the electrochemical stack 216 via the outlet anode ports and an outlet channel to direct this stream of water and oxygen toward the oxygen processor 208.

Some implementations of the hydrogen generator 106 may include a plurality of gas movers that include one or more of various types of fans (e.g., purge fans), blowers, or compressors. In some implementations, each one of the plurality of gas movers may be disposed within the electrochemical stack 216 or, alternatively, each one of the plurality of gas movers may be mounted externally to the electrochemical stack (e.g., to the roof or sidewall of the cabinet) to reduce the potential for heat or sparks to act as an inadvertent ignition source for contents of the generator.

As described above, the hydrogen generator 106 may also include a controller 114, which may be in electrical communication at least with one or more components of the generator. In general, the controller 114 may include one or more processors and a non-transitory computer-readable storage medium having stored thereon instructions for causing the one or more processors to control one or more of the startup, operation, or shutdown of any one or more of various aspects of the system 200 to facilitate safe and efficient operation. For example, the controller 114 may be in electrical communication at least with the electrochemical stack 216 and the power source 202. Continuing with this example, the controller 114 may interrupt power to the electrochemical stack 216 if an anomalous condition is detected. Further, or instead, the controller 114 may control the power to the electrochemical stack 216 after a startup protocol to reduce the likelihood of igniting a hydrogen-containing mixture in the electrochemical stack.

In certain implementations, the controller 114 may further, or instead, monitor one or more ambient conditions of the hydrogen generator 106 to facilitate taking one or more remedial actions before an anomalous condition results in damage to the system 200 and/or to an area near the system. In one particular example, given the potential damage that may be caused by the presence of an ignitable hydrogen-containing mixture within the electrochemical stack 216, the system 200 may include a plurality of gas sensors (referred to collectively as the plurality of gas sensors and individually as the first gas sensor, second gas sensor, or third gas sensor). Each of the plurality of gas sensors may include any one or more of various types of hydrogen sensors, such as one or more optical fiber sensors, electrochemical hydrogen sensors, thin-film sensors, and the like. Each one of the plurality of gas sensors may be calibrated to detect hydrogen concentration levels below the ignition limit of hydrogen to facilitate taking remedial action before an ignition event can occur. Toward this end, the controller 114 may be in electrical communication with each one of the plurality of gas sensors. The non-transitory computer-readable storage media of the controller 114 may have stored thereon instructions for causing one or more processors of the controller to interrupt electrical communication between the power source 202 and equipment in the electrochemical stack 216 based on a signal, received from one or more of the plurality of gas sensors and indicative of a dangerous hydrogen concentration. Additionally, or alternatively, the signal received from one or more of the plurality of gas sensors may indicate a rapid increase in hydrogen concentration. In general, the controller 114 may respond to any measured or detected condition of the hydrogen generator 106 and control one or more components of the generator accordingly.

In some implementations, the hydrogen generator 106 may be coupled to an external water source (e.g., water pipe, not shown) to receive a water supply suitable for meeting the demands of the electrochemical stack 216. The connection between the hydrogen generator 106 and the external water source may facilitate connection of the system 200 to an industrial water supply and, in some instances, to reduce the likelihood of damaging equipment in the event of a leak in the connection between the external water source. In still other implementations, the hydrogen generator 106 may include a recirculation circuit to receive an exit flow of water and oxygen from the anode portion of the electrochemical stack 216.

One or more of various gas-liquid separators suitable for separating oxygen from excess water may be included in the oxygen processor 208. For example, the oxygen processor 208 may include a dryer, a condenser, or another device that separates oxygen from excess water through gravity. The excess water may settle along a bottom portion of the oxygen processor 208, and oxygen is collecting along the top. The oxygen collected by the oxygen processor 208 may be directed out of the hydrogen generator 106.

Further, embodiments may include a hydrogen processor 210, which may include a hydrogen circuit, a dryer, and a hydrogen pump. In use, a product stream consisting of hydrogen and water (e.g., water vapor) may move from the anode side of the electrochemical stack 216 to the inlet portion of a dryer. The dryer may be, for example, pressure swing adsorption (PSA), a temperature swing adsorption (TSA) system, or a hybrid PSA-TSA system. The dryer may include one or more beds of a water-adsorbent material, such as activated carbon, silica, zeolite, or alumina. As the product mixture consisting of hydrogen and water moves through from the inlet portion to an outlet portion of the dryer, at least a portion of the water may be removed from the product mixture through adsorption of either water or hydrogen in the bed of water-adsorbent material.

The hydrogen pump may be, for example, an electrochemical pump. As used in this context, an “electrochemical pump” shall be understood to include a proton exchange membrane (i.e., a PEM electrolyte) disposed between an anode and a cathode. The hydrogen pump may generate protons moveable from the anode through the proton exchange membrane to the cathode to form pressurized hydrogen. Thus, such an electrochemical pump may be particularly useful for recirculating hydrogen within the hydrogen circuit at least because the electrochemical pumping provided by the electrochemical pump separates hydrogen from water in the mixture delivered to the hydrogen pump via the pump conduit while also pressurizing the separated hydrogen to facilitate moving the pressurized hydrogen to the inlet portion of the dryer.

Some embodiments may include storage tank 212, which may include a plurality of hydrogen storage tanks to contain the hydrogen created from the hydrogen processor 210. The storage tank 212 may be used to store excess hydrogen created by the hydrogen processor 210 to be used or shipped to users at a later time. In some instances, the produced hydrogen may not be stored in a storage tank but may instead be directly provided to an end user or to a storage tank external to the hydrogen generator. The storage tank 212 may be used to contain hydrogen until shipped to users, such as industrial outputs, among other users.

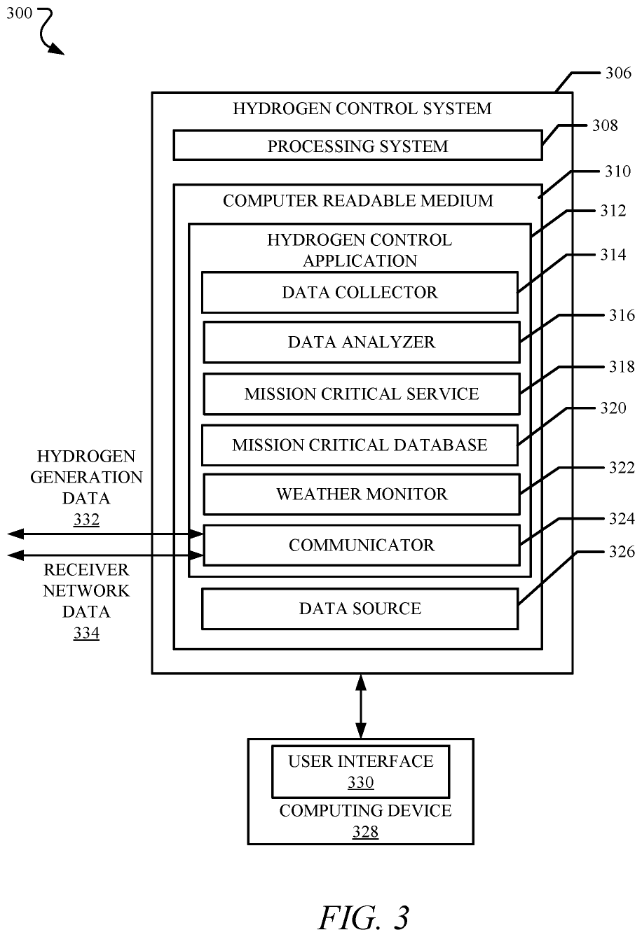

FIG. 3 illustrates an example block diagram of a controller for a hydrogen generation system with mission critical control. In general, the system 300 may include a hydrogen control system 306. In one implementation, the hydrogen control system 306 may be a part of the hydrogen generation environment 100 of FIG. 1. As shown in FIG. 3, the hydrogen control system 306 may be in communication with a computing device 328 providing a user interface 330. As explained in more detail below, the hydrogen control system 306 may be accessible to various users to request hydrogen for any number of downstream receivers 112. In some instances, access to the hydrogen control system 306 may occur through the user interface 330 executed on the computing device 328.

The hydrogen generation system 306 may include a hydrogen generation application 312 executed to perform one or more of the operations described herein. The hydrogen generation application 312 may be stored in a computer readable media 310 (e.g., memory) and executed on a processing system 308 of the hydrogen generation system 306 or other type of computing system, such as that described below. For example, the hydrogen generation application 312 may include instructions that may be executed in an operating system environment, such as a Microsoft Windows™ operating system, a Linux operating system, or a UNIX operating system environment. By way of example and not limitation, non-transitory computer readable medium 310 comprises computer storage media, such as non-transient storage memory, volatile media, nonvolatile media, removable media, and/or non-removable media implemented in a method or technology for storage of information, such as computer readable instructions, data structures, program modules, or other data.

The hydrogen generation application 312 may also utilize a data source 326 of the computer readable media 310 for storage of data and information associated with the hydrogen generation system 306. For example, the hydrogen generation application 312 may store received data or inputs, processing details, and/or output information, and the like. As described in more detail below, data associated with hydrogen production/requests, including amount requested, date, time, and amount provided, may be stored and accessed via the user interface 330. Data associated with a mission critical control of the hydrogen generation may also be stored at the data source 326.

To provide such mission critical services of hydrogen generations, the hydrogen generation application 312 may include several components that may be executed to provide mission critical control over the hydrogen generator 106. For example, the hydrogen generation application 312 may include a data collector 314 to collect and store data from the hydrogen generator 106 and the receiver network 116. In some embodiments, the data collector 314 may utilize a communicator 324 of the hydrogen control application 312 to communicate with the hydrogen generator 106 and/or the receiver network 116 to receive said data. For example, the communicator 324 may communicate with the receiver network 116 to receive a request for hydrogen production received at a downstream system 112. The received request may be stored in the data source 326 (or some other data storage device) by the data collector 314. The hydrogen control application 312 may also, in response to receiving the request, transmit one or more control instructions to the hydrogen generator 106 to generate hydrogen for the downstream receiver 112. The data collector 314 may store data associated with any aspect of the generation of hydrogen, including hydrogen generation data 332 received from one or more hydrogen generators 106 and receiver network data 334 received from a receiver network corresponding to hydrogen generated for a downstream receiver 112. As discussed in more detail below, the collected data may be utilized to provide mission critical control over the hydrogen generation.

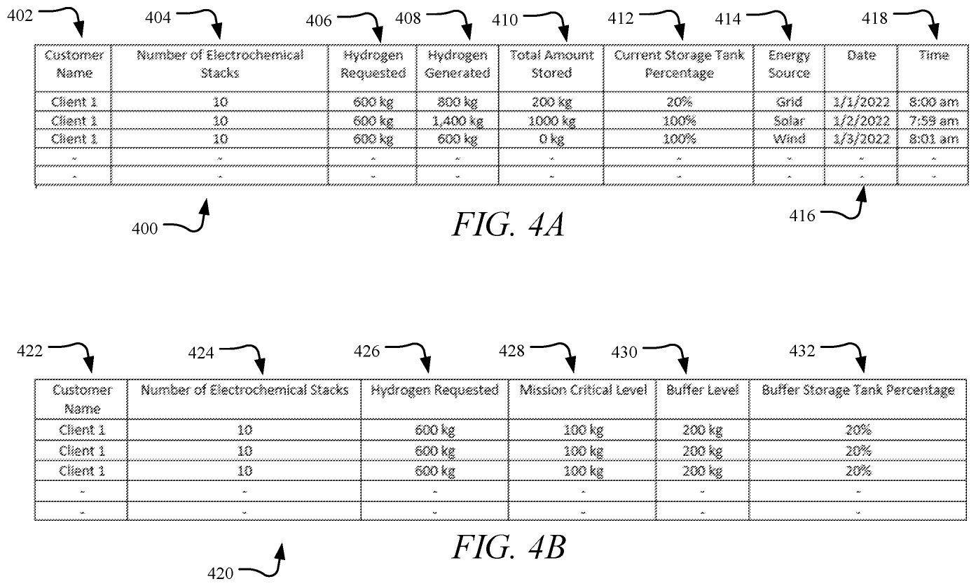

Further embodiments may include a data analyzer 316 to analyze and/or otherwise process data stored by the data collector. In one implementation, the data analyzer 316 may obtain data from any of the databases managed by or otherwise in communication with the data collector 314. For example, the hydrogen control application 312 may maintain a database of historical information for one or more receivers or customers of the hydrogen generation environment 100. FIG. 4A illustrates one example of such a historical database 400. As illustrated, the historical database 400 may include entries for a customer or receiver name 402, a number of electrochemical stacks used to provide the receiver with requested hydrogen 404, an amount of requested hydrogen 406, the hydrogen generated 408, a total amount of the generated hydrogen stored in a storage tank 410, a current percentage of the storage tank consumed 412, an energy source used 404, and the date 416 and time 418 of the storage of the data. More or less data may be stored in the historical database 400 and the data may be stored in any format, not necessarily in a table as illustrated in FIG. 4A. The data included in the historical database 400 may be generated by the hydrogen control application 312 or obtained from the hydrogen generator 106 and/or the receiver network 116. In the example shown, an entry for the particular receiver of hydrogen is generated every day on or around 8:00 am. The receiver may, however, request and receive hydrogen at a different frequency or upon request. Further and as explained in more detail below, some amount of generated hydrogen may be stored in storage tank 212 for use during mission critical circumstances of the downstream receiver 112 as managed by a mission critical service 318 and mission critical database 320. In addition, one or more input energy sources 110 may be used by the hydrogen generator 106, which may or may not be selected by the control system 102 based on input received from the weather monitor 322 discussed below.

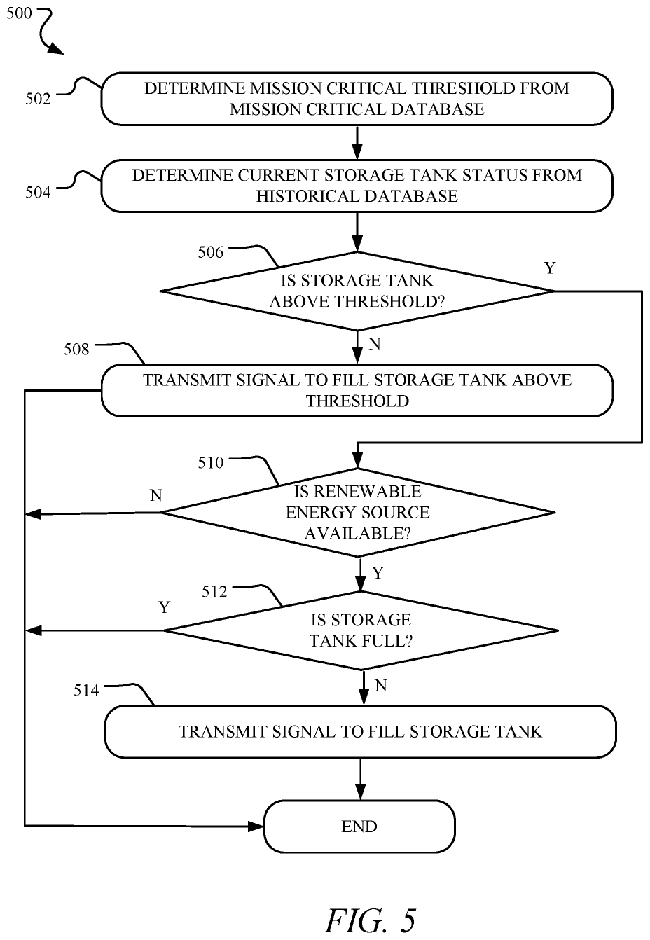

As mentioned, the hydrogen control system 306 may include a mission critical service 318 and mission critical database 320 to manage mission critical circumstances for downstream receivers 112. FIG. 5 illustrates a method 500 for providing mission critical services for a downstream receiver 112 of a hydrogen generator 106 or generators. In one implementation, the operations of the method 500 may be performed or executed by the mission critical service 318 of the hydrogen control application 312. In general, however, the operations may be performed by any component or components of the hydrogen generation environment 100 of FIG. 1, including the controller 114 of the hydrogen generator 106 and/or a system of the receiver network 116.

At operation 502, a mission critical threshold may be determined from the mission critical database 320. In general, the mission critical database 320 may store data associated with providing a mission critical service for a downstream receiver 112 of the hydrogen generator 106. FIG. 4B illustrates one example of a mission critical database 420 for use in providing a mission critical service. As illustrated, the mission critical database 420 may include entries for a customer or receiver name 422, a number of electrochemical stacks used to provide the receiver with requested hydrogen 424, and a buffer storage tank percentage 426. More or less data may be stored in the mission critical database 420 and the data may be stored in any format, not necessarily in a table as illustrated. Further, the mission critical database 420 may be maintained by any component of the hydrogen generation environment 100, including the control system 102 and/or the controller 114 of the hydrogen generator 106.

Determining the mission critical threshold may include, in one implementation, the mission critical service 318 obtaining the threshold 428 or level from the mission critical database 420. In one example, the control system 102 may receive a desired threshold value from the receiver network 116 and store the threshold value 428 in the mission critical database 420. The receiver network 116 may receive the threshold value through an input to the network, such as from a user or customer of the receiver network. Alternatively, the threshold value 428 may be generated by the receiver network 116 or the control system 102 based on data stored in the historical database 400. For example, the data analyzer 316 may analyze the data stored in the historical database 400 and determine a mission critical threshold value 428. The mission critical threshold value 428 may be based on any data or information associated with the downstream receiver 112, including but not limited to, an historical amount of requested hydrogen and a frequency of requests for generated hydrogen received from the downstream receiver. Through this analysis, the mission critical threshold value 428 for the downstream receiver 112 may be determined to ensure that the hydrogen for the receiver does not drop below the mission critical level.

At operation 504, a current storage tank status or capacity may be determined, perhaps from the historical database 400. In particular, the historical database 400 may include data, such as a column of information, that indicates a current percentage 412 of the capacity of the storage tank 212. Using the historical database 400 of FIG. 4A as an example, the storage tank capacity 412 for the downstream receiver 112 is 20% on January 1, and 100% for both January 2 and January 3. Thus, the current storage tank status may comprise the last measurement of the capacity of the storage tank 212 stored in the historical database 400 or any other data storage of the hydrogen generating environment 100. In other instances, the current storage tank status may be stored as a volume measurement, such as kilograms (kgs) of stored hydrogen. In still another example, the current storage tank status may be stored in the mission critical database 420, such as the buffer storage tank percentage 432 illustrated in the table of FIG. 4B. In still other implementations, the current storage tank may be determined through a request made to the storage tank 212 or controller 114 of the hydrogen generator 106 or any other storage tank of a hydrogen generating system. Regardless of how the information is obtained, a current status of the hydrogen storage tank 212 may be obtained or otherwise determined.

At operation 506, the mission critical threshold value may be compared to the storage tank status to determine if the status is equal to or above the threshold value. For example, the current storage tank status, as obtained from the historical database 400 or the mission critical database 420, may indicate that the tank is at 100% capacity. In comparison, the mission critical threshold value (as noted in the mission critical database 420) may be a 20% storage tank capacity. Thus, in this example, the current storage tank status is greater than the threshold value. In other circumstances, however, the current storage tank status may be less than the mission critical threshold value. Also, the mission critical threshold value may comprise a capacity of the storage tank measured in kilogram or other measurement, as may the current storage tank status. As noted above, the current storage tank status may be a measured capacity of the storage tank obtained at a last request or at some time in the past and does not necessarily correlate to a present storage tank capacity.

If it is determined that the storage tank status is not above the mission critical threshold value, a signal may be transmitted to the controller 114 of the hydrogen generator 106 to cause the electrochemical stack 216 to generate more hydrogen at operation 508. In one implementation, the mission critical service 318 of the hydrogen control application 312 may generate the instruction to produce more hydrogen and utilize the communicator 324 to transmit the instruction to the hydrogen generator 106. The controller 114 may then activate the electrochemical stack 216 to generate hydrogen for storage in the storage tank 212. The controller 114 may also monitor the capacity of the storage tank 212 to ensure that the storage tank capacity exceeds or meets the mission critical threshold value. In this manner, the hydrogen generator 106 may be controlled such that a minimum level of hydrogen is maintained within the storage tank 212 to provide at least a mission critical amount of hydrogen to the downstream receiver 112.

It should be appreciated that the mission critical threshold value may be more than the minimum level of hydrogen needed to endure proper operation of the downstream receiver 112. For example and as illustrated in the mission critical database 420 of FIG. 4B, a mission critical level of hydrogen for the downstream receiver 112 may be 100 kg of hydrogen, as shown in column 428. Although the mission critical level for the downstream receiver 112 is 100 kg in this example, the mission critical threshold may be set at some value more than the critical level, such as the 200 kg buffer level illustrated in column 430. The difference between the mission critical threshold value 430 and the mission critical level 428 of needed hydrogen may provide the environment 100 with a buffer amount of hydrogen in the storage tank to ensure that the hydrogen level does not drop below the mission critical level by being maintained at or above the mission critical threshold value 430.

In addition, the hydrogen generation environment 100 may be configured to utilize renewable energy sources when available in preference over a non-renewable energy source. For example, the input resources 110 for the hydrogen generator 106 may include non-renewable energy sources (such as a power grid) and renewable energy sources (such as solar, wind, geothermal, etc.) to provide power to the hydrogen generator 106 for producing hydrogen. The controller 114 of the generator 106 may select between different input energy sources for powering the power source 202 of the generator. However, to ensure the mission critical threshold is maintained in the storage tank 212, the controller 114 may select a non-renewable energy source for the hydrogen generator 106 when it is determined that the storage tank is below the threshold value. In general, renewable energy sources may be less reliable than non-renewable energy sources, such as during low winds for a wind farm energy source or during a cloudy day for solar energy sources. As non-renewable energy sources may be more reliably available, the controller 114 may be instructed to select a non-renewable energy source for refilling the storage tank in circumstances in which the capacity of the storage tank has dropped below the mission critical threshold level.

Alternatively, in circumstances in which the storage tank status is above the mission critical threshold value, it may be determined that if a renewable energy source is available for providing power to the hydrogen generator 106 at operation 510. To determine the availability of a renewable energy source, the weather monitor 322 of the hydrogen control application 312 may be used. In some implementations, the weather monitor 322 may include a weather module and/or a weather database 158, which allows the hydrogen control application 312 to request and/or receive weather information. In some embodiments, the weather information may be received from a third-party network in which weather information is provided for the day, week, or month. In some embodiments, the weather information may be real-time weather information for a location of the hydrogen generator 106 or a location of the renewable energy source, such as a wind farm location or location of one or more solar panels. Such weather information may also include a cost for each renewable or non-renewable energy source. The weather monitor 322 may store the received information in the weather database of the weather monitor. In some embodiments, a sun forecast may use the UV index to determine the amount of sunlight for the day. In some embodiments, a wind forecast may use the peak strength of the wind during the day. The database may then be used to determine if the weather forecast for the day allows for the use of renewable energy such as solar panels or wind turbines. In some embodiments, the weather forecast may be updated in real-time by the weather monitor 322.

Determining if a renewable energy source is available may include determining a weather condition at or near the renewable energy source and a cost for using such resources. If it is determined that a renewable energy source is not available, the controller 114 may be instructed to not produce additional hydrogen from the electrochemical stack 216 as the amount in the storage tank 212 is above the mission critical threshold value. However, if a renewable energy source is available, it may be determined if the storage tank 212 is full at operation 512. If the storage tank 212 is full, the method 500 may end. If the storage tank 212 is not full, an instruction may be generated and transmitted to the controller 114 to activate the electrochemical stack 216 to fill the storage tank 212. In some instances, filling the storage tank 212 may include monitoring the capacity of the storage tank and filling the tank to a target capacity that is less than 100% of the capacity of the tank. For example, the storage tank 212 may be filled to a requested level received from the receiver network 116 based on a need for the downstream receiver 112.

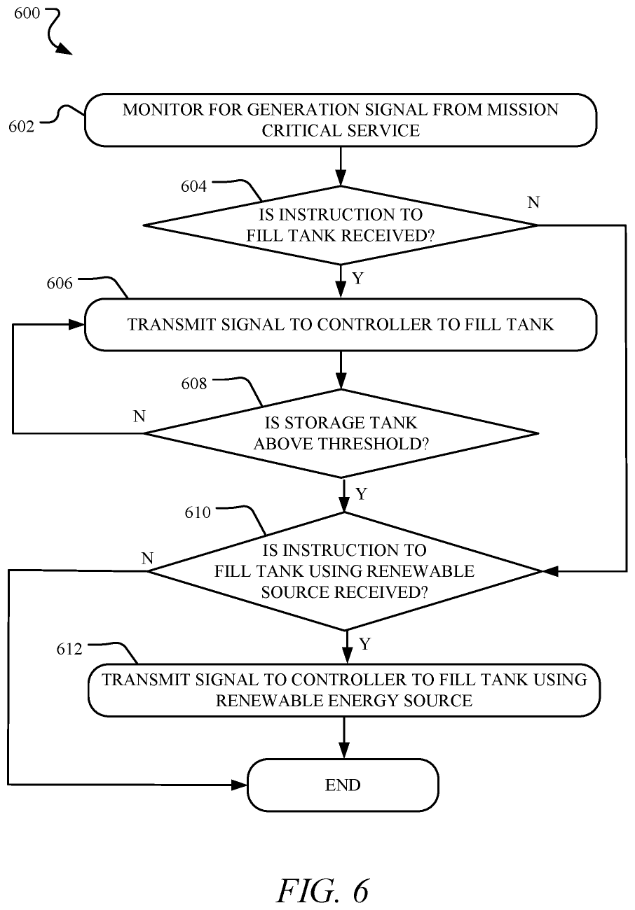

FIG. 6 illustrates a method 600 for the control system 102 of the hydrogen generating environment 100 to provide mission critical services for a downstream receiver 112. At operation 602, the control system 102 may monitor for a generation signal from the mission critical service 318 of the hydrogen control application 312. As discussed above, the mission critical service 318 may monitor the status of a storage tank 212 and determine if the storage tank capacity is above a mission critical threshold value. If the storage tank capacity is below the mission critical threshold value, the mission critical service 318 may provide an alert to fill the storage tank 212 above the threshold value. The generation signal from the mission critical service 318 may then be received by the control system 102 at operation 604.

If the instruction to generate addition hydrogen is received, the control system 102 may transmit a signal to the controller 114 or controllers of one or more hydrogen generators 106 to begin generating hydrogen and fill the storage tank 212. The controller 114 may, in turn, control the power source 202 to provide power to the electrochemical stack 216 to begin producing hydrogen for storage in the tank 212. In one implementation, the controller 114 may select a non-renewable energy source 110 to provide power to the electrochemical stack. At operation 608, the controller 114 may determine if the storage tank status is above the mission critical threshold value and, if not, continue to fill the tank with generated hydrogen by returning to operation 606.

If the storage tank status is above the mission critical threshold value or the instruction to fill the tank 212 is not received from the mission critical service 318, the control system 102 may determine if an instruction to fill the tank using a renewable energy source is received at operation 610. In some instances, the instruction to use renewable energy may be provided based on data maintained and/or analyzed by the weather monitor 322 of the hydrogen control application 312. If an instruction is received to fill the storage tank 212 using a renewable energy source, a signal may be transmitted to the controller 114 to activate the electrochemical stack 216 using a renewable power source 202 at operation 612. If such an instruction is not received, the control system 102 may end the method without filling the storage tank 212 further. Through this method, the hydrogen generator 106 may be controlled to provide a mission critical level of hydrogen in the storage tank 212, perhaps utilizing non-renewable but reliable energy sources, while also preferencing the use of renewable energy sources to fill the tank in circumstances in which a level of hydrogen has not dropped below the mission critical threshold level to ensure proper operation of a downstream receiver.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present systems and methods, which, as a matter of language, might be said to fall therebetween.

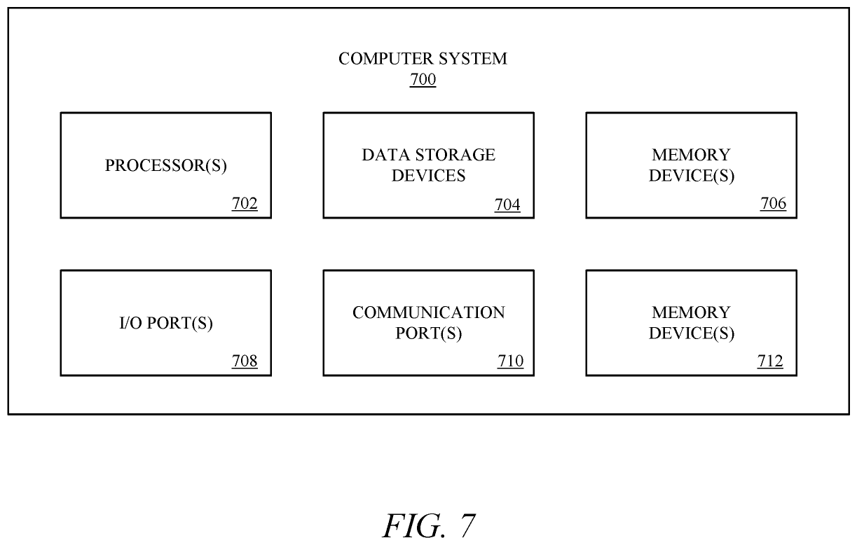

Referring to FIG. 7, a detailed description of an example computing system 700 having one or more computing units that may implement various systems and methods discussed herein is provided. The computing system 700 may be part of a controller 114, may be in operable communication with various implementation discussed herein, may run various operations related to the method discussed herein, and may be part of overall systems discussed herein. The computing system 700 may be applicable to, for example, the controller 114 discussed with respect to the various figures and may be used to implement the various methods described herein. It will be appreciated that specific implementations of these devices may be of differing possible specific computing architectures, not all of which are specifically discussed herein but will be understood by those of ordinary skill in the art. It will further be appreciated that the computer system may be considered and/or include an ASIC, FPGA, microcontroller, or other computing arrangement. In such various possible implementations, more or fewer components discussed below may be included, interconnections and other changes made, as will be understood by those of ordinary skill in the art.

The computer system 700 may be a computing system that is capable of executing a computer program product to execute a computer process. Data and program files may be input to the computer system 700, which reads the files and executes the programs therein. Some of the elements of the computer system 700 are shown in FIG. 7, including one or more hardware processors 702, one or more data storage devices 704, one or more memory devices 706, and/or one or more ports 708-712. Additionally, other elements that will be recognized by those skilled in the art may be included in the computing system 700 but are not explicitly depicted in FIG. 7 or discussed further herein. Various elements of the computer system 700 may communicate with one another by way of one or more communication buses, point-to-point communication paths, or other communication means not explicitly depicted in FIG. 7. Similarly, in various implementations, various elements disclosed in the system may or not be included in any given implementation.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The presently described technology in various possible combinations may be implemented, at least in part, in software stored on the data stored device(s) 704, stored on the memory device(s) 706, and/or communicated via one or more of the ports 708-712, thereby transforming the computer system 700 in FIG. 7 to a special purpose machine for implementing the operations described herein.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 700 includes one or more ports, such as an input/output (I/O) port 708, a communication port 710, and a sub-systems port 712, for communicating with other computing, network, or vehicle devices. It will be appreciated that the ports 708-712 may be combined or separate and that more or fewer ports may be included in the computer system 700. The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. In some examples, such inputs may be distinct from the various system and method discussed with regard to the preceding figures. Similarly, the output devices may convert electrical signals received from computing system 700 via the I/O port 708 into signals that may be sensed or used by the various methods and system discussed herein. The input device may be an alphanumeric input device, including alphanumeric and other keys for communicating information and/or command selections to the processor 702 via the I/O port 708.

The environment transducer devices convert one form of energy or signal into another for input into or output from the computing system 700 via the I/O port 708. For example, an electrical signal generated within the computing system 700 may be converted to another type of signal, and/or vice-versa. In one implementation, the environment transducer devices sense characteristics or aspects of an environment local to or remote from the computing device 700.

In one implementation, a communication port 710 may be connected to a network by way of which the computer system 700 may receive network data useful in executing the methods and systems set out herein as well as transmitting information and network configuration changes determined thereby. The communication port 710 connects the computer system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 710 to communicate with one or more other machines, either directly over a point-to-point communication path, over a wide area network (WAN) (e.g., the Internet), over a local area network (LAN), over a cellular (e.g., third generation (3G), fourth generation (4G), fifth generation (4G)) network, or over another communication means.

The system set forth in FIG. 7 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Various embodiments of the disclosure have been discussed in detail. While specific implementations are discussed, it should be understood that this is done for illustration purposes only. A person skilled in the relevant art will recognize that other components and configurations may be used without parting from the spirit and scope of the disclosure. Thus, the description and drawings herein are illustrative and are not to be construed as limiting. Numerous specific details are described to provide a thorough understanding of the disclosure. However, in certain instances, well-known or conventional details have not been described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Thus, references to one or an embodiment in the present disclosure can be references to the same embodiment or any embodiment; and such references mean at least one of the embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.”

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open ended term, like “comprising” or “including,” it is understood that direct support should be afforded also to “consisting essentially of” language as well as “consisting of” language as if stated explicitly and vice versa.

What is claimed is:

1. A hydrogen generation system comprising:
a hydrogen generator including:
an electrochemical stack producing hydrogen; and
a power source in electrical communication with the electrochemical stack for receiving an input power signal from a plurality of input power sources, the plurality of input power sources comprising at least a renewable energy source and a non-renewable energy source; and
a control system comprising a processor and a non-transitory computer-readable medium encoded with instructions, which when executed by the processor, cause the processor to:
determine a mission critical threshold value of a storage tank capacity associated with a downstream receiver of generated hydrogen; and
control, based on a comparison of the mission critical threshold value to a current storage tank capacity measurement, the hydrogen generator to fill a storage tank with hydrogen by selecting the non-renewable energy source or the renewable energy source.

2. The hydrogen generation system of claim 1, wherein the instructions cause the processor to select the non-renewable energy source when the mission critical threshold value is greater than the current storage tank capacity measurement.

3. The hydrogen generation system of claim 1, wherein the instructions cause the processor to select the renewable energy source when the mission critical threshold value is less than the current storage tank capacity measurement.

4. The hydrogen generation system of claim 3, wherein the instructions further causing the processor to:
analyze a database of weather information associated with a location of the renewable energy source to determine an availability of the renewable energy source to fill the storage tank with hydrogen.

5. The hydrogen generation system of claim 1, wherein the renewable energy source comprises one of a solar panel array, a wind farm, or a geothermal energy source.

6. The hydrogen generation system of claim 1, wherein the non-renewable energy source comprises a power grid.

7. The hydrogen generation system of claim 1, wherein the hydrogen generator further comprises a controller in communication with the power source to select the input power signal for the power source, the instructions further causing the processor to:
transmit an instruction to the controller to select the input power signal for the power source based on the comparison of the mission critical threshold value to the current storage tank capacity measurement.

8. The hydrogen generation system of claim 1, wherein the mission critical threshold value is received at the control system from a receiver network associated with the downstream receiver.

9. The hydrogen generation system of claim 1, wherein the mission critical threshold value is derived from a historical data associated with the downstream receiver.

10. The hydrogen generation system of claim 9, wherein deriving the mission critical threshold value is based at least on a received minimum requirement of hydrogen for the downstream receiver.

11. The hydrogen generation system of claim 1, wherein the current storage tank capacity measurement is obtained from a database of the control system and based on a measurement of the storage tank in response to a request for hydrogen received from a receiver network associated with the downstream receiver.

12. A method comprising:
determining a mission critical threshold value associated with a downstream receiver of hydrogen generated by a hydrogen generator, the hydrogen generator comprising:
an electrochemical stack to generate hydrogen;
a storage tank to store generated hydrogen; and
a power source in electrical communication with the electrochemical stack to receive an input power signal from a plurality of input power sources, the plurality of input power sources comprising at least a renewable energy source and a non-renewable energy source; and
selecting, based on a comparison of the mission critical threshold value to a current storage tank capacity measurement of the storage tank, the non-renewable energy source or the renewable energy source to fill a storage tank with hydrogen.

13. The method of claim 12, wherein the one or more instructions select the non-renewable energy source when the mission critical threshold value is greater than the current storage tank capacity measurement.

14. The method of claim 12, wherein the one or more instructions select the renewable energy source when the mission critical threshold value is less than the current storage tank capacity measurement.

15. The method of claim 14, further comprising:
analyzing a database of weather information associated with a location of the renewable energy source to determine an availability of the renewable energy source to fill the storage tank with hydrogen.

16. The method of claim 12, further comprising:
receiving, from a receiver network associated with the downstream receiver, the mission critical threshold value, wherein the mission critical threshold value based at least on a received minimum requirement of hydrogen for the downstream receiver.

17. The method of claim 12, further comprising:
deriving the mission critical threshold value from a historical data associated with the downstream receiver, the historical data stored in a historical database.

18. The method of claim 12, further comprising:
receiving the current storage tank capacity measurement from a database, the measurement obtained in response to a request for hydrogen received from a receiver network associated with the downstream receiver.

19. A non-transitory computer-readable storage medium having computer-executable program instructions stored thereon that when executed by a processor, cause a computing device to perform:
determining a mission critical threshold value associated with a downstream receiver of hydrogen generated by a hydrogen generator, the hydrogen generator comprising:
an electrochemical stack to generate hydrogen;
a storage tank to store generated hydrogen; and
a power source in electrical communication with the electrochemical stack to receive an input power signal from a plurality of input power sources, the plurality of input power sources comprising at least a renewable energy source and a non-renewable energy source; and
transmitting, to the hydrogen generator, one or more instructions to:
select, based on a comparison of the mission critical threshold value to a current storage tank capacity measurement of the storage tank, the non-renewable energy source or the renewable energy source to fill a storage tank with hydrogen.

20. The non-transitory computer-readable storage medium of claim 19, wherein the one or more instructions select the non-renewable energy source when the mission critical threshold value is greater than the current storage tank capacity measurement.

21. The non-transitory computer-readable storage medium of claim 19, wherein the one or more instructions select the renewable energy source when the mission critical threshold value is less than the current storage tank capacity measurement.

22. The non-transitory computer-readable storage medium of claim 19, wherein the renewable energy source comprises one of a solar panel array, a wind farm, or a geothermal energy source and the non-renewable energy source comprises a power grid.
